(19) United States
(12) Patent Application Publication
(10) Pub. No.: US 2013/0155270 A1
(43) Pub. Date: Jun. 20, 2013

(54) ELECTRONIC CAMERA

(71) Applicant: SANYO ELECTRIC CO., LTD., Osaka (JP)

(72) Inventor: Yoshiyuki Tsuda, Osaka (JP)

(73) Assignee: SANYO ELECTRIC CO., LTD., Osaka (JP)

(21) Appl. No.: 13/691,967

(22) Filed: Dec. 3, 2012

(30) Foreign Application Priority Data
Dec. 16, 2011 (JP) 2011-276306

(51) Int. Cl. H04N 5/225

(52) U.S. Cl. CPC H04N 5/225
USPC 348/222.1

(57) ABSTRACT

An electronic camera includes an imager. An imager has an imaging surface capturing an optical image expressing a scene and outputs an electronic image corresponding to the optical image. An acquirer acquires a plurality of electronic images outputted from the imager at a plurality of timings different to one another. A detector detects a motion of the imaging surface in association with a process of the acquirer. A definer defines an image region of a predefined size expressing a scene common among the plurality of electronic images acquired by the acquirer, with reference to a detection result of the detector. A combiner combines a plurality of partial images belonging to the image region defined by the definer, out of the plurality of electronic images acquired by the acquirer.

### CROSS REFERENCE OF RELATED APPLICATION

The disclosure of Japanese Patent Application No. 2011-276306, which was filed on Dec. 16, 2011, is incorporated herein by reference.

### BACKGROUND OF THE INVENTION

1. Field of the Invention

The present invention relates to an electronic camera, and more particularly, relates to an electronic camera which creates a combined image based on a plurality of images acquired at timings different to one another.

2. Description of the Related Art

According to one example of this type of camera, a motion vector expressing a hand shake of an imaging surface is detected in parallel with a continuous photograph. A deviation in position among the plurality of images acquired by the continuous photograph is corrected with reference to the motion vector detected in parallel with the continuous photograph. The plurality of images acquired by the continuous photograph are combined after such a positional rearrangement.

However, in the above-described camera, an angle of field of the combined image varies according to a magnitude of the motion vector, and thus, there is a limit to an operability

### SUMMARY OF THE INVENTION

An electronic camera according to the present invention, comprises: an imager which has an imaging surface capturing an optical image expressing a scene and outputs an electronic image corresponding to the optical image; an acquirer which acquires a plurality of electronic images outputted from the imager at a plurality of timings different to one another; a detector which detects a motion of the imaging surface in association with a process of the acquirer; a definer which defines an image region of a predefined size expressing a scene common among the plurality of electronic images acquired by the acquirer, with reference to a detection result of the detector; and a combiner which combines a plurality of partial images belonging to the image region defined by the definer, out of the plurality of electronic images acquired by the acquirer.

According to the present invention, an imaging control program, which is recorded on a non-temporary recording medium in order to control an electronic camera provided with an imager which has an imaging surface capturing an optical image expressing a scene and which outputs an electronic image corresponding to the optical image, the imaging control program causing a processor of the electronic camera to execute: an acquiring step of acquiring a plurality of electronic images outputted from the imager at a plurality of timings different to one another; a detecting step of detecting a motion of the imaging surface in association with a process in the acquiring step; a defining step of defining an image region of a predefined size expressing a scene common among the plurality of electronic images acquired in the acquiring step; and a combining step of combining a plurality of partial images belonging to the image region defined in the defining step, out of the plurality of electronic images acquired in the acquiring step.

According to the present invention, an imaging control method executed by an electronic camera provided with an imager which has an imaging surface capturing an optical image expressing a scene and which outputs an electronic image corresponding to the optical image, the imaging control method comprising: an acquiring step of acquiring a plurality of electronic images outputted from the imager at a plurality of timings different to one another; a detecting step of detecting a motion of the imaging surface in association with a process in the acquiring step; a defining step of defining an image region of a predefined size expressing a scene common among the plurality of electronic images acquired in the acquiring step; and a combining step of combining a plurality of partial images belonging to the image region defined in the defining step, out of the plurality of electronic images acquired in the acquiring step.

The above described characteristics and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of a mapping state of an SDRAM applied to the embodiment in FIG. 2;

FIG. 4 is an illustrative view showing one example of an allocation state of an evaluation area on an imaging surface;

FIG. 5 is a graph showing one example of a relationship between a focal distance and a cut-out size;

FIG. 6 is an illustrative view showing one portion of an operation of the embodiment in FIG. 2;

FIG. 7 is an illustrative view showing another portion of the operation of the embodiment in FIG. 2;

FIG. 8 is an illustrative view showing still another portion of the operation of the embodiment in FIG. 2;

FIG. 9 is a flowchart showing one portion of an operation of a CPU applied to the embodiment in FIG. 2;

FIG. 10 is a flowchart showing another portion of the operation of the CPU applied to the embodiment in FIG. 2;

FIG. 11 is a flowchart showing still another portion of the operation of the CPU applied to the embodiment in FIG. 2;

FIG. 12 is a flowchart showing yet another portion of the operation of the CPU applied to the embodiment in FIG. 2; and

FIG. 13 is a block diagram showing a configuration of another embodiment of the present invention.

### DETAILED DESCRIPTION OF THE PREFERRED EMBODIMENTS

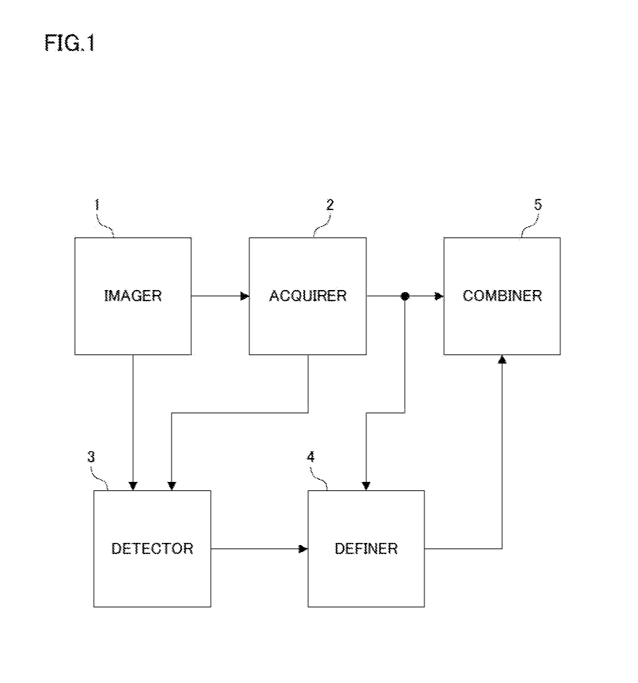

With reference to FIG. 1, an electronic camera according to one embodiment of the present invention is basically configured as follows: An imager 1 has an imaging surface capturing an optical image expressing a scene and outputs an electronic image corresponding to the optical image. An acquirer 2 acquires a plurality of electronic images outputted from the imager 1 at a plurality of timings different to one another. A detector 3 detects a motion of the imaging surface in association with a process of the acquirer 2. A definer 4 defines an image region of a predefined size expressing a scene common among the plurality of electronic images acquired by the acquirer 2, with reference to a detection result of the detector 3. A combiner 5 combines a plurality of partial images belonging to the image region defined by the definer 4, out of the plurality of electronic images acquired by the acquirer 2.

The image region defined by the definer 4 corresponds to a region expressing the scene common among the plurality of electronic images acquired at the timings different to one another. The combined image is created based on the plurality of partial images belonging to the image region thus defined. Herein, the size of the image region, that is, an angle of field of the combined image, is fixed irrespective of the motion of the imaging surface. Thereby, an operability is improved.

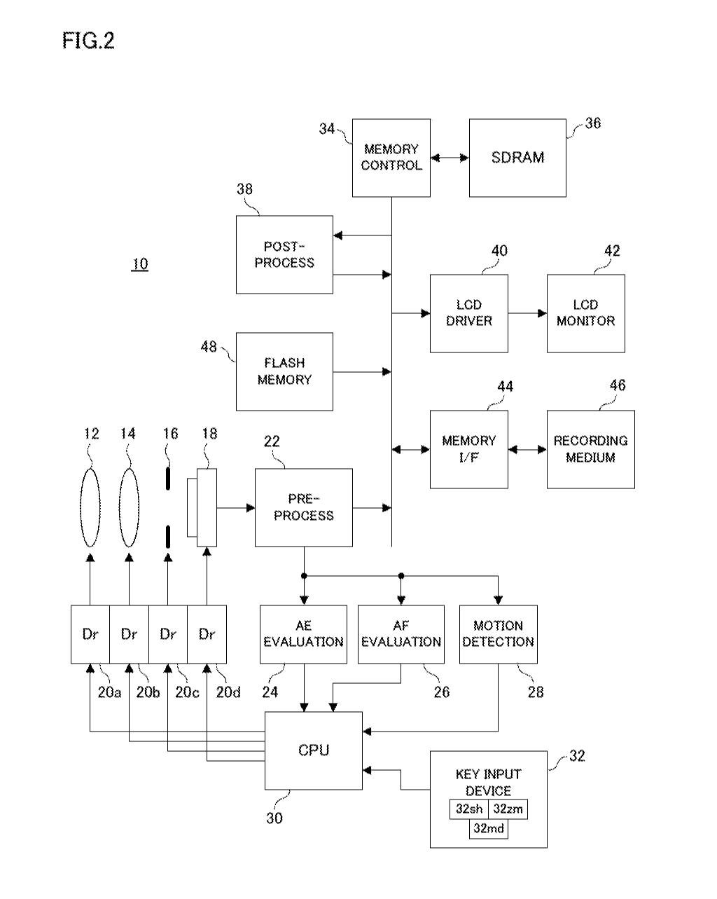

With reference to FIG. 2, a digital camera 10 according to this embodiment includes a zoom lens 12, a focus lens 14, and an aperture unit 16 respectively driven by drivers 20a to 20c. An optical image that undergoes these members enters, with irradiation, an imaging surface of an imager 18, and is subjected to a photoelectric conversion. Thereby, an electric charge corresponding to the optical image is produced.

When a power source is applied, a CPU 30 commands a driver 20d to repeat an exposure operation and an electric-charge reading-out operation in order to execute a moving-image taking process. In response to a vertical synchronization signal Vsync periodically generated from a Signal

Generator (SG) not shown, the driver 20d exposes the imaging surface and reads out the electric charges produced on the imaging surface in a raster scanning manner. From the imager 18, raw image data based on the read-out electric charges is periodically outputted.

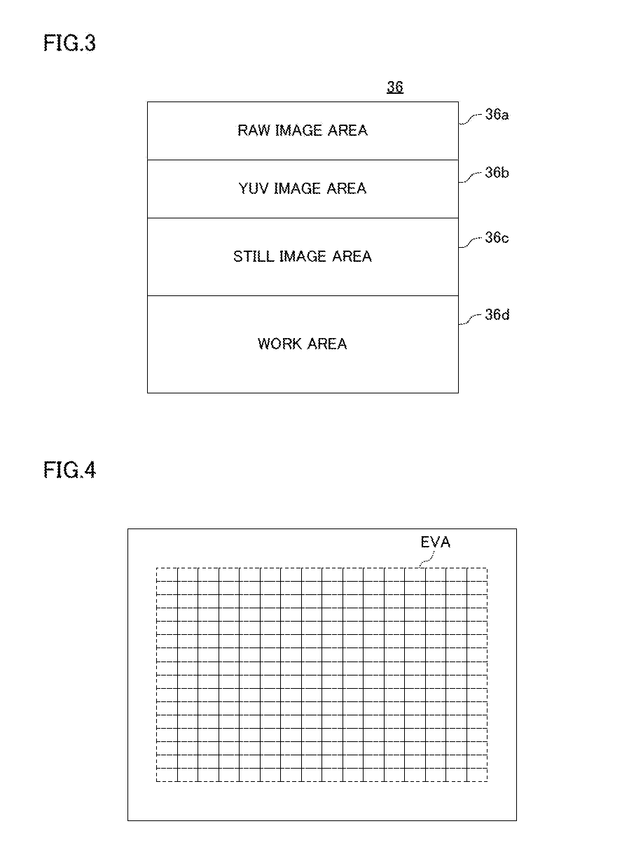

A pre-processing circuit 22 performs processes, such as digital clamp, pixel defect correction, and gain control, on the raw image data outputted from the imager 18. The raw image data on which such pre-processes are performed is written into a raw image area 36a (see FIG. 3) of an SDRAM 36 through a memory control circuit 34.

A post-processing circuit 38 reads out the raw image data accommodated in the raw image area 36a through the memory control circuit 34, and performs a color separating process, a white balance adjusting process, and a YUV converting process on the read-out raw image data. The YUV-formatted image data produced thereby is written into a YUV image area 36b (see FIG. 3) of the SDRAM 36 through the memory control circuit 34.

An LCD driver 40 repeatedly reads out the image data accommodated in the YUV image area 36b through the memory control circuit 34, and drives an LCD monitor 42 based on the read-out image data. As a result, a real-time moving image (live view image) expressing a scene captured on the imaging surface is displayed on a monitor screen.

With reference to FIG. 4, an evaluation area EVA is allocated to a center of the imaging surface. The evaluation area EVA is divided into 16 portions in each of a horizontal direction and a vertical direction; therefore, 256 divided areas form the evaluation area EVA. Moreover, in addition to the above-described processes, the pre-processing circuit 22 shown in FIG. 2 executes a simple RGB converting process in which the raw image data is simply converted into RGB data.

An AE evaluating circuit 24 integrates RGB data belonging to the evaluation area EVA, out of the RGB data produced by the pre-processing circuit 22, at each generation of the vertical synchronization signal Vsync. Thereby, 256 integral values, that is, 256 AE evaluation values, are outputted from the AE evaluating circuit 24 in response to the vertical synchronization signal Vsync. An AF evaluating circuit 26 integrates a high frequency component of the RGB data belonging to the evaluation area EVA, out of the RGB data produced by the pre-processing circuit 22, at each generation of the vertical synchronization signal Vsync. Thereby, 256 integral values, that is, 256 AF evaluation values, are outputted from the AF evaluating circuit 26 in response to the vertical synchronization signal Vsync.

When a shutter button 32sh provided in a key input device 32 is in a non-operated state, the CPU 30 executes a simple AE process based on the 256 AE evaluation values outputted from the AE evaluating circuit 24, and calculates an appropriate EV value. An aperture amount and an exposure time period defining the calculated appropriate EV value are set to the drivers 20c and 20d, and as a result, a brightness of a live view image is moderately adjusted.

When a zoom button 32zm provided in the key input device 32 is operated, the CPU 30 moves the zoom lens 12, through the driver 20a, in an optical axis direction. As a result, a magnification of the live view image is changed.

When the shutter button 32sh is half-depressed, the CPU 30 executes a strict AE process in which the AE evaluation values are referenced, and calculates an optimal EV value. An aperture amount and an exposure time period defining the calculated optimal EV value are also set to the drivers 20c and 20d, and as a result, the brightness of the live view image is strictly adjusted. The CPU 30 further executes an AF process based on the 256 AF evaluation values outputted from the AF evaluating circuit 26. The focus lens 14 moves in the optical axis direction by the driver 20b in order to search a focal point, and is arranged at the focal point discovered thereby. As a result, a sharpness of the live view image is improved.

An imaging mode is switched by a mode changing switch 32md between a normal mode and an HDR (High Dynamic Range) mode.

When the shutter button 32sh is fully depressed in a state where the normal mode is selected, the CPU 30 executes a still-image taking process only once. As a result, one frame of the image data expressing a scene at a time point when the shutter button 32sh is fully depressed is evacuated from the YUV image area 36b to a still image area 36c (see FIG. 3).

When the shutter button 32sh is fully depressed in a state where the HDR mode is selected, the CPU 30 takes three frames of the image data corresponding respectively to three exposure amounts different to one another, into the still image area 36c, and creates one frame of combined image data based on the three frames of the image data taken (to be described in detail later). The combined image data is created in a work area 36d (see FIG. 3), and thereafter, is sent back to the still image area 36c.

When one frame of the still image data or the combined image data is obtained in this way, the CPU 30 commands a memory I/F 44 to execute a recording process. The memory I/F 44 reads out one frame of the image data accommodated in the still image area 36c through the memory control circuit 34, and records the read-out image data on a recording medium 46 in a file format.

In the HDR process, the CPU 30, firstly, acquires YUV-formatted image data (image data in a first frame) that is based on the raw image data outputted from the imager 18 after the shutter button 32sh is fully depressed. The image data in the first frame is evacuated from the YUV image area 36b to the still image area 36c.

Subsequently, the CPU 30 changes an exposure setting (=the aperture amount and/or the exposure time period) so that an exposure amount of the imaging surface indicates a times the exposure amount corresponding to the optimal EV value, and acquires the YUV-formatted image data (image data in a second frame) that is based on the raw image data outputted from the imager 18 after the change. The image data in the second frame also is evacuated from the YUV image area 36b to the still image area 36c.

Subsequently, the CPU 30 changes an exposure setting (=the aperture amount and/or the exposure time period) so that the exposure amount on the imaging surface indicates 1/α times the exposure amount corresponding to the optimal EV value, and acquires the YUV-formatted image data (image data in a third frame) that is based on the raw image data outputted from the imager 18 after the change. The image data in the third frame also is evacuated from the YUV image area 36b to the still image area 36c.

On the other hand, a motion detecting circuit 28 repeatedly creates motion information indicating the motion of the imaging surface between the frames, and applies the created motion information to the CPU 30. Strictly speaking, the motion information corresponds to information indicating a motion of the imaging surface in a direction orthogonal to the optical axis, a direction around the optical axis, and a direction along the optical axis. The CPU 30 acquires the motion information corresponding to a three-frame period after the shutter button 32sh is fully depressed, from the motion detecting circuit 28.

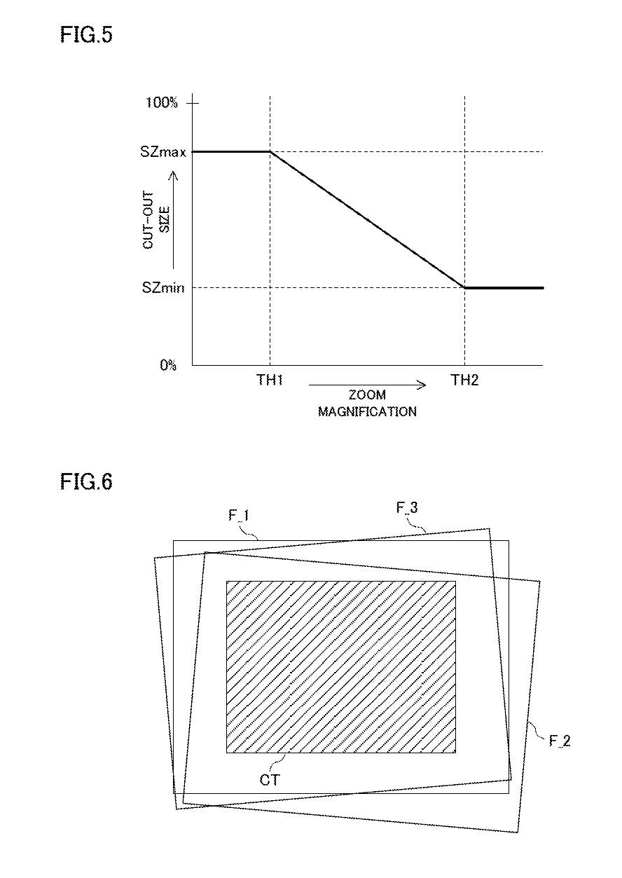

When the three frames of the image data and the motion information are thus acquired, the CPU 30 adjusts a size of a cut-out region CT, based on the position of the zoom lens 12, that is, a zoom magnification, according to a graph shown in FIG. 5, and initializes the arrangement of the cut-out region CT.

According to FIG. 5, the size of the cut-out region CT is set to “SZmax” in a range in which the zoom magnification falls below a threshold value TH1, set to “SZmin” in a range in which the zoom magnification exceeds a threshold value TH2, and reduced linearly from “SZmax” to “SZmin” as the zoom magnification increases in the range between the threshold value TH1 and the threshold value TH2. Further, an initial position of the cut-out region CT is placed at a center of the image data in a first frame. Therefore, the cut-out region CT has a size that reduces as the zoom magnification increases and is placed at the center of the image data in the first frame.

Subsequently, the CPU 30 sets a variable K to each of “2” and “3”, and executes a cut-out region adjusting process for each setting value. In the cut-out region adjusting process, firstly a deviation between the image data in the first frame and that in a K-th frame is calculated based on the motion information acquired as described above, and based on the calculated deviation, a region common to the image data in the first frame to the K-th frame (=common region) is specified.

If the specified common region encompasses the cut-out region CT, then the CPU 30 maintains the arrangement of the cut-out region CT at a current time point. On the other hand, if the specified common region does not encompass the cut-out region CT, then the CPU 30 determines whether or not the specified common region is able to cover the cut-out region CT and executes a process different depending on a determination result.

Specifically, when it is possible for the common region to cover the cut-out region CT, the CPU 30 moves the cut-out region CT to a position encompassed by the common region. The position after the movement should be placed at a position closest to the center of the image data in the first frame. On the other hand, when it is not possible for the common region to cover the cut-out region CT, the CPU 30 executes an error process. As a result, a notification to prompt another imaging operation (another operation of the shutter button 32sh) is outputted.

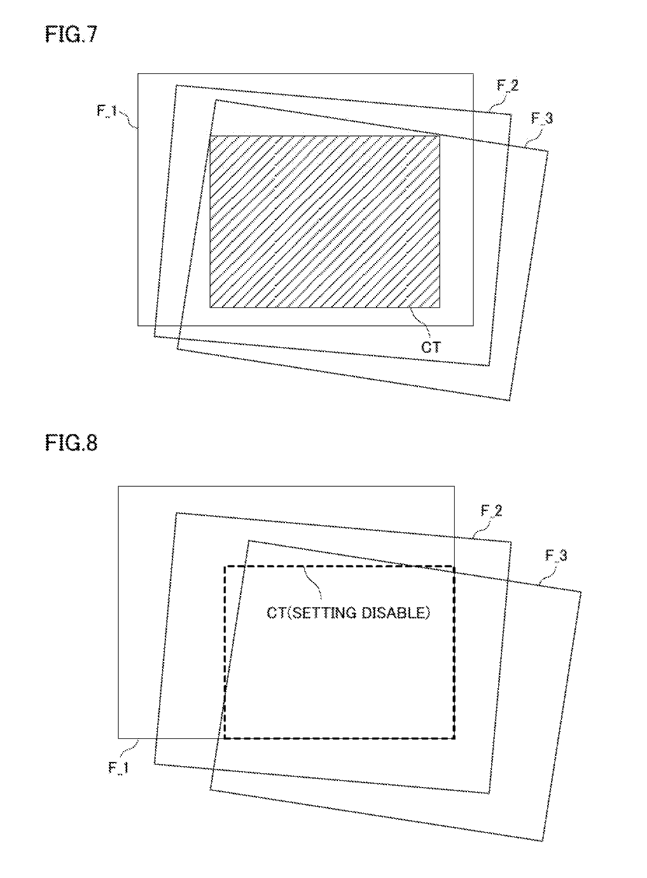

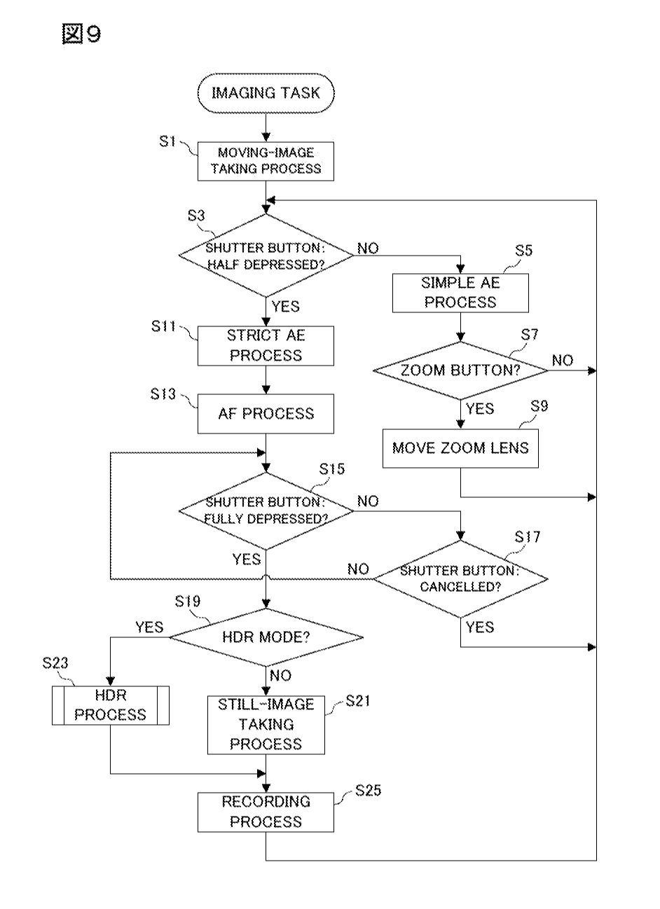

Therefore, when three frames to be noticed are defined as “F_1”, “F_2”, and “F_3”, if frames F_1 to F_3 are transitioned as shown in FIG. 6, then a region hatched in the same FIG. 6 is set as the cut-out region CT. Furthermore, when the frames F_1 to F_3 are transitioned as shown in FIG. 7, a region hatched in the same FIG. 7 is set as the cut-out region CT. On the other hand, when the frames F_1 to F_3 are transitioned as shown in FIG. 8, the error process is executed instead of setting of the cut-out region CT.

When it is successful to set the cut-out region CT, the CPU 30 cuts out three frames of partial image data belonging to the set cut-out region CT, from three frames of the image data, respectively, and combines the three frames of the cut-out partial image data. Thereby, one frame of the combined image data is created. Such a combining process is executed on the work area 36d, and the created combined image data is sent back to the still image area 36c.

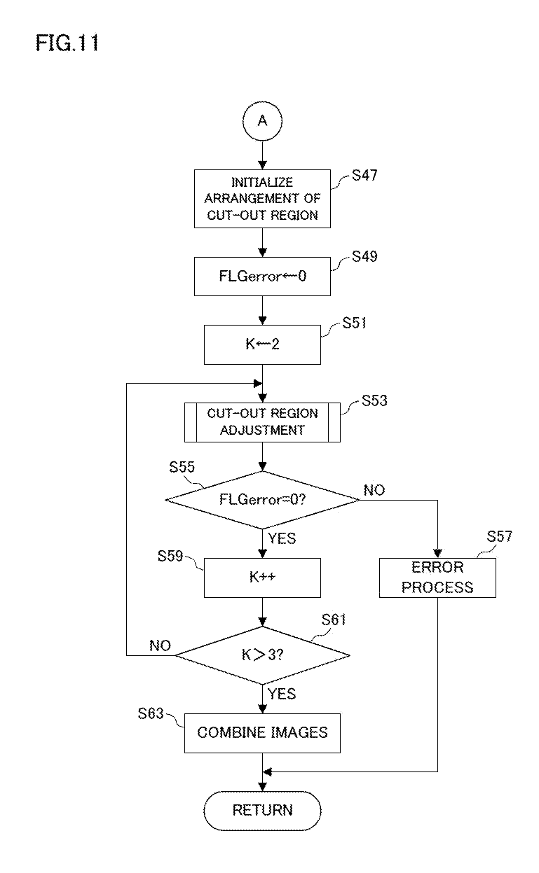

The CPU 30 executes a plurality of tasks including an imaging task shown in FIG. 9 to FIG. 12, in a parallel manner, under the control of a multitask OS. It is noted that a control program corresponding to these tasks is stored in a flash memory 48.

With reference to FIG. 9, in a step S1, a moving-image taking process is executed. As a result, a live view image expressing a scene captured on the imaging surface is displayed on the LCD monitor 42. In a step S3, it is determined whether or not the shutter button 32sh is half-depressed, and when a determination result is NO, the simple AE process is executed in a step S5. As a result, the brightness of the live view image is adjusted moderately.

In a step S7, it is determined whether or not the zoom button 32zm is operated, and when a determination result is NO, the process directly returns to the step S3 while when the determination result is YES, the process returns to the step S3 after moving the zoom lens 12 in the optical axis direction in a step S9. As a result of the process in the step S9, the magnification of the live view image is changed.

If the determination result of the step S3 is updated from NO to YES, the strict AE process is executed in a step S11, and the AF process is executed in a step S13. The brightness of the live view image is strictly adjusted by the strict AE process, and the sharpness of the live view image is improved by the AF process.

In a step S15, it is determined whether or not the shutter button 32sh is fully depressed. In a step S17, it is determined whether or not the operation of the shutter button 32sh is canceled. When the determination result in the step S17 is YES, the process directly returns to the step S3, and when the determination result in the step S15 is YES, the process returns to the step S3 after undergoing processes in steps S19 to S25.

In the step S19, which of the imaging mode at this time point, that is, the normal mode or the HDR mode, is determined. When the imaging mode at this time point is the normal mode, the still-image taking process is executed in the step S21, and when the imaging mode at this time point is the HDR mode, the HDR process is executed in the step S23.

As a result of the still-image taking process in the step S21, one frame of the image data expressing a scene at a time point at which the shutter button 32sh is fully depressed is evacuated from the YUV image area 36b to the still image area 36c. Moreover, as a result of the HDR process in the step S23, three frames of the image data respectively corresponding to the three exposure amounts different to one another are taken in the still image area 36c, and one frame of the combined image data is created on the work area 36d. The created combined image data is sent back to the still image area 36c.

Upon completion of the process of the step S21 or S23, the process proceeds to the step S25, and the memory I/F 44 is commanded to execute the recording process. The memory I/F 44 reads out one frame of the image data accommodated in the still image area 36c through the memory control circuit 34, and records the read-out image data on a recording medium 46 in a file format.

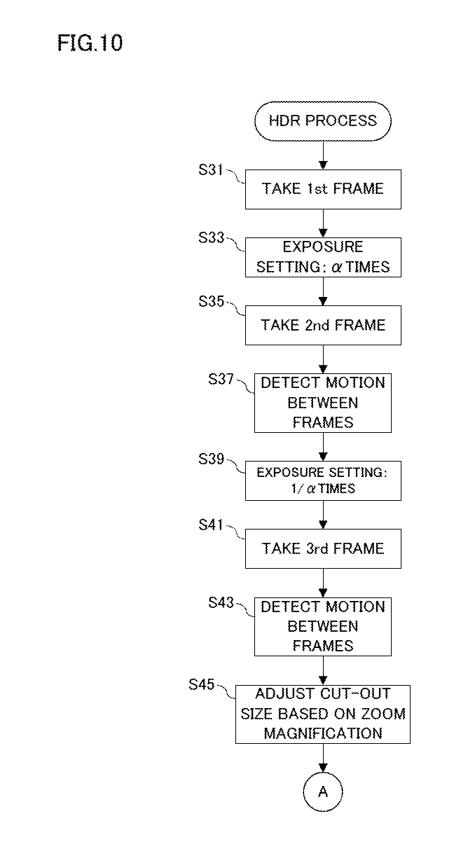

The HDR process in the step S23 is executed according to a subroutine shown in FIG. 10 to FIG. 12. In a step S31, YUV-formatted image data that is based on the raw image data outputted from the imager 18 after the shutter button 32sh is fully depressed (=the image data in a first frame) is evacuated from the YUV image area 36b to the still image area 36c. In a step S33, the exposure setting (=the aperture amount and/or the exposure time period) is changed so that the exposure amount of the imaging surface indicates a times the exposure amount corresponding to the optimal EV value.

In a step S35, YUV-formatted image data that is based on the raw image data outputted from the imager 18 after the process of the step S33 (=the image data in a second frame) is evacuated from the YUV image area 36b to the still image area 36c. In a step S37, the motion information indicating a motion of the imaging surface from an exposure in the first frame to an exposure in the second frame is acquired from the motion detecting circuit 28.

In a step S39, the exposure setting (=the aperture amount and/or the exposure time period) is changed so that the exposure amount of the imaging surface indicates 1/α times the exposure amount corresponding to the optimal EV value. In a step S41, YUV-formatted image data that is based on the raw image data outputted from the imager 18 after the process of the step S39 (=the image data in a third frame) is evacuated from the YUV image area 36b to the still image area 36c. In a step S43, the motion information indicating a motion of the imaging surface from an exposure in the second frame to an exposure in the third frame is acquired from the motion detecting circuit 28.

In a step S45, the size of the cut-out region CT is adjusted based on the position of the zoom lens 12, that is, the zoom magnification, and in a step S47, the arrangement of the cut-out region CT is initialized. The cut-out region CT has a size that reduces as the zoom magnification increases and is placed at the center of the image data in the first frame.

In a step S49, a flag FLGerror is set to “0”, in a step S51, a variable K is set to “2”, and in a step S53, the cut-out region adjusting process is executed. As a result of the cut-out region adjusting process, the common region common among the image data in the first frame to the K-th frame is specified, and the arrangement of the cut-out region is adjusted so as to be contained within the specified common region. It is noted that when it is not possible for the specified common region to cover the cut-out region CT, the flag FLGerror is updated to “1” instead of the arrangement of the cut-out region CT being adjusted.

In a step S55, it is determined whether or not the flag FLGerror indicates “0”, and when a determination result is NO, the error process is executed in a step S57. As a result of the error process, a notification to prompt another imaging operation (another operation of the shutter button 32sh) is outputted. Upon completion of the error process, the process is restored to a routine at a hierarchical upper level.

On the other hand, when the determination result in the step S55 is YES, the variable K is incremented in a step S59, and whether or not the value of the incremented variable K exceeds “3” is determined in a step S61. When a determination result is NO, the process returns to the step S53, and when the determination result is YES, the process proceeds to a step S63.

In the step S63, three frames of the partial image data belonging to the cut-out region CT are cut out from the three frames of the image data taken in the steps S31, S35, and S41, respectively, and the three frames of the cut-out partial image data are combined. Thereby, one frame of the combined image data is created. The image combining process is executed on the work area 36d, and the combined image data created thereby is returned to the still image area 36c. Upon completion of the image combining process, the process is restored to a routine at a hierarchical upper level.

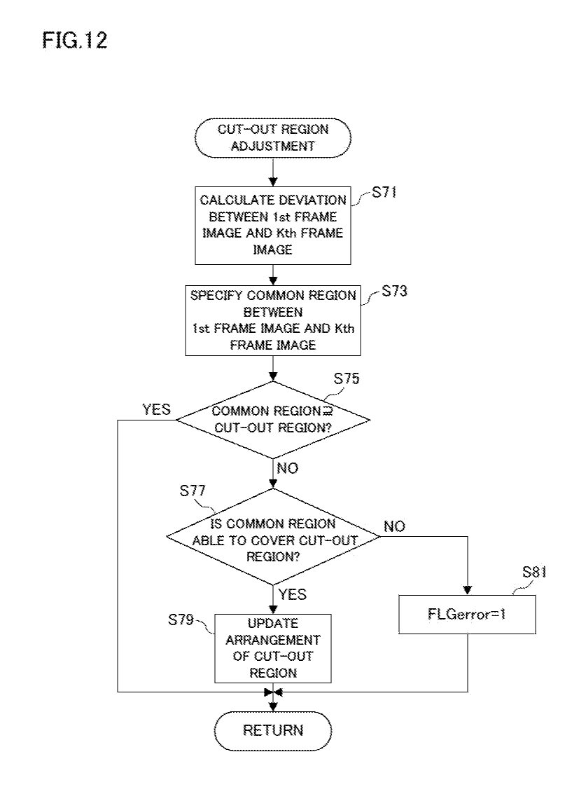

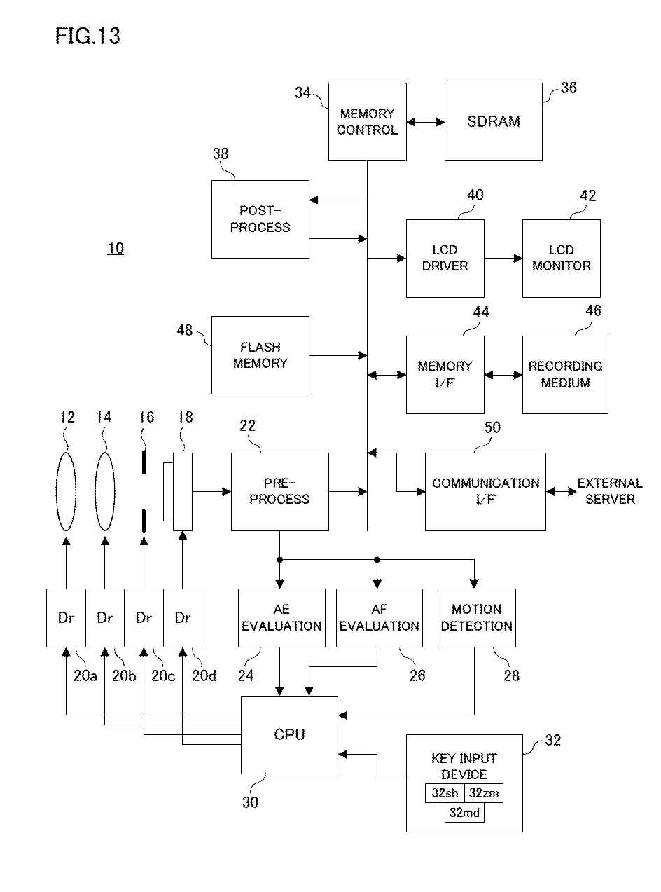

The cut-out region adjusting process in the step S53 is executed according to a subroutine shown in FIG. 12. In a step S71, a deviation between the image data in the first frame and the image data in the K-th frame is calculated based on the motion information acquired in the step S37 or step S43. In a step S73, the region common to from the image data in the first frame to the image data in the K-th frame (=common region) is specified based on the calculated deviation.

In a step S75, it is determined whether or not the specified common region encompasses the cut-out region CT, and when a determination result is YES, the process is restored to a routine at a hierarchical upper level while when the determination result is NO, the process proceeds to a step S77. In the step S77, it is determined whether or not the specified common region is able to cover the cut-out region CT. When a determination result is YES, the process proceeds to a step S79 in which the cut-out region CT is moved to the position encompassed by the specified common region. The position after the movement should be placed at a position closest to the center of the image data in the first frame. On the other hand, when the determination result is NO, the process proceeds to a step S81 so as to update the flag FLGerror to “1”. Upon completion of the process in the step S79 or

S81, the process restores to a routine at an upper hierarchical level.

As understood from the above description, the imager 18 includes an imaging surface capturing an optical image expressing a scene and outputs raw image data corresponding to the optical image. The outputted raw image data is converted into the YUV-formatted image data by the processes of the pre-processing circuit 22 and the postprocessing circuit 38. The CPU 30 acquires the three frames of the YUV-formatted image data that is based on the three frames of the raw image data outputted from the imager 18 at timings different to one another (S31, S35, and S41), and furthermore, the CPU 30 acquires from the motion detecting circuit 28 the motion information indicating the motion of the imaging surface in this three-frames period (S37 and S43). The CPU 30 further defines, based on the above-described motion information, the cut-out region CT which expresses a scene common among the three frames of the acquired image data and which indicates a predefined size (S45 to S47 and S79), and combines the three frames of the partial image data belonging to the defined cut-out region CT (S63).

The cut-out region CT defined based on the motion information is equivalent to the region expressing the scene common among the three frames of the image data acquired at timing different to one another. The combined image data is created based on the three frames of the partial image data belonging to the cut-out region CT defined in this way. In this case, the size of the cut-out region CT, that is, an angle of field of the combined image data, is fixed to a predefined value irrespective of the motion of the imaging surface. Thereby, an operability is improved.

It is noted that in this embodiment, when the arrangement of the cut-out region CT is adjusted so as to be encompassed in the common region, the cut-out region CT is to be moved toward the center of the image data in the first frame. However, the cut-out region CT may be moved toward a center of the image data in the second frame or the third frame, rather than the first frame.

Furthermore, in this embodiment, a multi-task OS and the control program equivalent to a plurality of tasks executed by the multi-task OS are stored in the flash memory 48 in advance. However, as shown in FIG. 13, a communication I/F 50 is provided in the digital camera 10, and one portion of a control program is prepared, as an internal control program, from the first in the flash memory 48 while another portion of the control program may be acquired, as an external control program, from an external server. In this case, the above-described operations are implemented by the cooperation of the internal control program and the external control program.

Moreover, in this embodiment, the process executed by the CPU 30 is divided into a plurality of tasks as described above. However, each of the tasks may be further divided into a plurality of smaller tasks, and furthermore, one portion of the plurality of the divided smaller tasks may be integrated with other tasks. Also, in a case of dividing each of the tasks into a plurality of smaller tasks, all or one portion of these may be obtained from an external server.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An electronic camera, comprising:
an imager which has an imaging surface capturing an optical image expressing a scene and outputs an electronic image corresponding to the optical image;
an acquirer which acquires a plurality of electronic images outputted from said imager at a plurality of timings different to one another;
a detector which detects a motion of the imaging surface in association with a process of said acquirer;
a definer which defines an image region of a predefined size expressing a scene common among the plurality of electronic images acquired by said acquirer, with reference to a detection result of said detector; and
a combiner which combines a plurality of partial images belonging to the image region defined by said definer, out of the plurality of electronic images acquired by said acquirer.

2. An electronic camera according to claim 1, further comprising:
a magnification adjuster which adjusts a zoom magnification in response to a zoom operation; and
a size adjuster which adjusts a value of the predefined size so as to be differed depending on the zoom magnification adjusted by said magnification adjuster.

3. An electronic camera according to claim 1, further comprising a notifier which notifies an error instead of said definer executing the process, when a size of the scene noticed by said definer falls below a reference.

4. An electronic camera according to claim 1, wherein said definer executes a defining process after the completion of the process by said acquirer.

5. An electronic camera according to claim 1, further comprising an exposure setter which sets a plurality of exposure amounts different to one another corresponding respectively to the plurality of timings noticed by said acquirer.

6. An imaging control program, which is recorded on a non-temporary recording medium in order to control an electronic camera provided with an imager which has an imaging surface capturing an optical image expressing a scene and which outputs an electronic image corresponding to the optical image, said imaging control program causing a processor of the electronic camera to execute:
an acquiring step of acquiring a plurality of electronic images outputted from said imager at a plurality of timings different to one another;
a detecting step of detecting a motion of the imaging surface in association with a process in said acquiring step;
a defining step of defining an image region of a predefined size expressing a scene common among the plurality of electronic images acquired in said acquiring step; and
a combining step of combining a plurality of partial images belonging to the image region defined in said defining step, out of the plurality of electronic images acquired in said acquiring step.

7. An imaging control method executed by an electronic camera provided with an imager which has an imaging surface capturing an optical image expressing a scene and which outputs an electronic image corresponding to the optical image, said imaging control method comprising:
an acquiring step of acquiring a plurality of electronic images outputted from said imager at a plurality of timings different to one another;
a detecting step of detecting a motion of the imaging surface in association with a process in said acquiring step;
a defining step of defining an image region of a predefined size expressing a scene common among the plurality of electronic images acquired in said acquiring step; and
a combining step of combining a plurality of partial images belonging to the image region defined in said defining step, out of the plurality of electronic images acquired in said acquiring step.
